(19) United States
(12) Patent Application Publication
(10) Pub. No.: US 2019/0358781 A1
(43) Pub. Date: Nov. 28, 2019

(54) HOLE DRILLING JIG ASSEMBLY

(71) Applicant: Tom Valento, Vadnais Heights, MN (US)

(72) Inventor: Tom Valento, Vadnais Heights, MN (US)

(21) Appl. No.: 15/986,143

(22) Filed: May 22, 2018

(51) Int. Cl. B25B 7/12

(52) U.S. Cl. CPC B25B 7/123

(57) ABSTRACT

A hole drilling jig assembly for drilling holes in a support at a precise location includes a pair of locking pliers that include a pair of jaws and an adjustment screw. An eyebolt is coupled to the adjustment screw and a pulling line may be coupled to the eyebolt for pulling on the locking pliers. A pair of panels is each coupled to a respective one of the jaws. Each of the panels is compressed against a support when the locking pliers are closed. Each of the panels has a pair of apertures extending therethrough to facilitate holes to be drilled through the support at a precise location.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to jig devices and more particularly pertains to a new jig device for drilling holes in a support at a precise location.

### BRIEF SUMMARY OF THE INVENTION

An embodiment of the disclosure meets the needs presented above by generally comprising a pair of locking pliers that include a pair of jaws and an adjustment screw. An eyebolt is coupled to the adjustment screw and a pulling line may be coupled to the eyebolt for pulling on the locking pliers. A pair of panels is each coupled to a respective one of the jaws. Each of the panels is compressed against a support when the locking pliers are closed. Each of the panels has a pair of apertures extending therethrough to facilitate holes to be drilled through the support at a precise location.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hole drilling jig assembly according to an embodiment of the disclosure.

FIG. 2 is a top view of a pair of plates of embodiment of the disclosure.

FIG. 3 is a perspective view of an eyebolt of an embodiment of the disclosure.

FIG. 4 is a perspective in-use view of an embodiment of the disclosure.

### DETAILED DESCRIPTION OF THE INVENTION

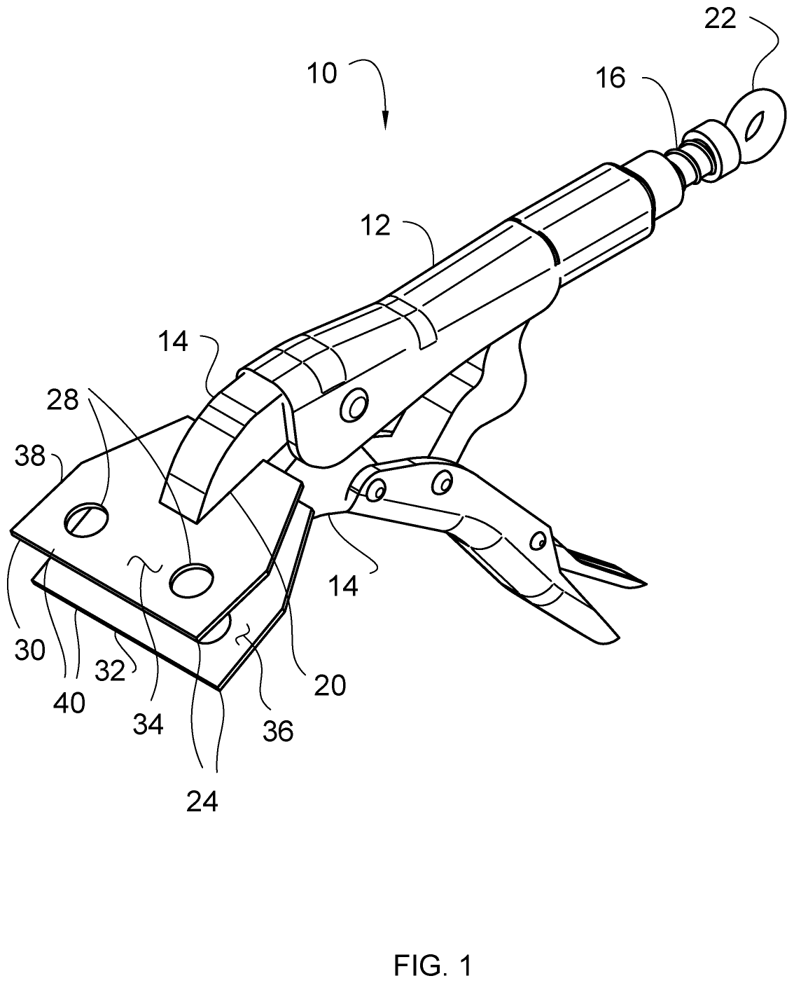

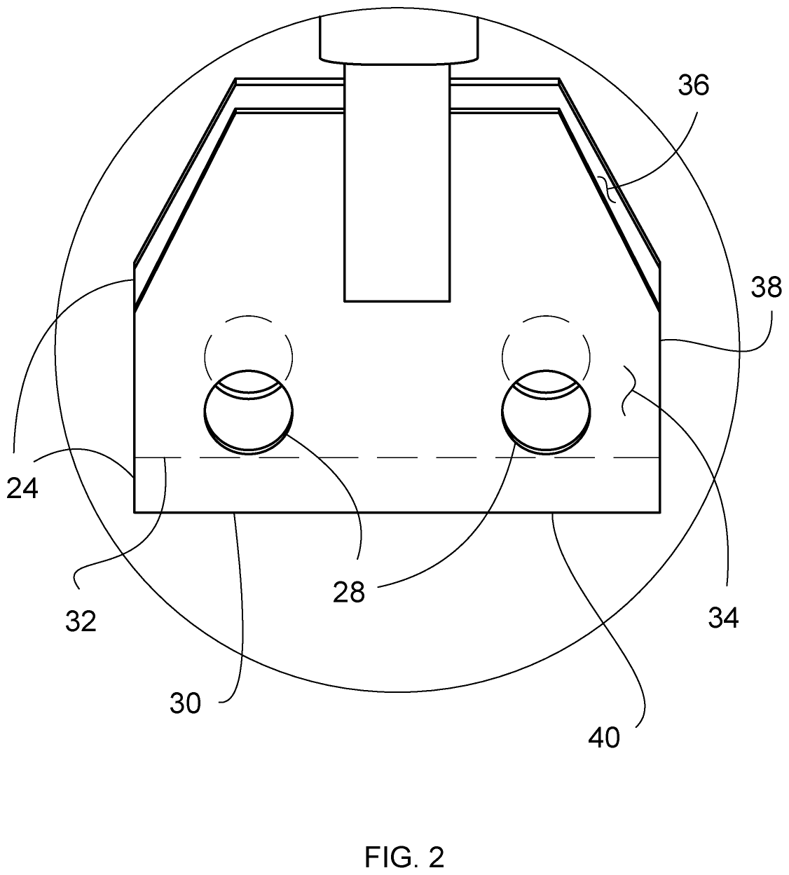

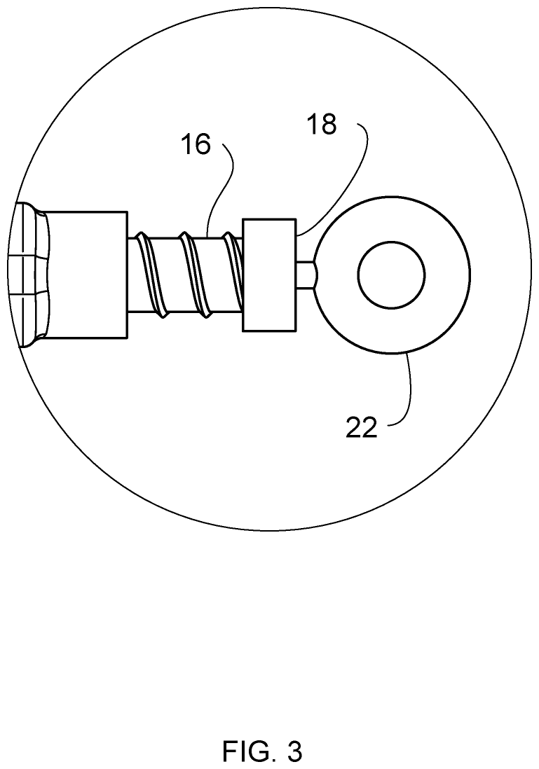

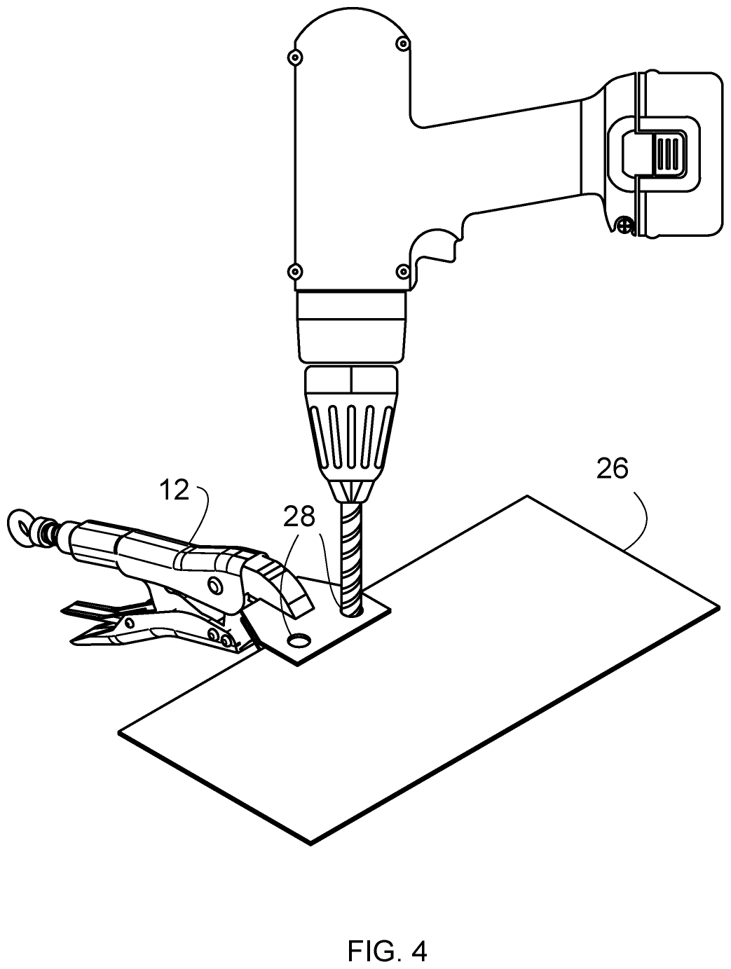

With reference now to the drawings, and in particular to FIGS. 1 through 4 thereof, a new jig device embodying the principles and concepts of an embodiment of the disclosure and generally designated by the reference numeral 10 will be described.

As best illustrated in FIGS. 1 through 4, the hole drilling jig assembly 10 generally comprises a pair of locking pliers 12 and the locking pliers 12 include a pair of jaws 14 and an adjustment screw 16. The adjustment screw 16 has a distal end 18 with respect to the locking pliers 12. The pair of locking pliers 12 may be Vise-Grip pliers manufactured by Irwin Tools or the like. Each of the jaws 14 has an interior surface 20 and the interior surface 20 of each of the jaws 14 faces each other. An eyebolt 22 is coupled to the distal end 18 of the adjustment screw 16. The eyebolt 22 may be coupled to a pulling line for pulling on the locking pliers 12. Thus, pulling on the locking pliers 12 is enhanced as compared to pulling on the locking pliers 12 with hands.

A pair of panels 24 is provided and each of the panels 24 is coupled to a respective one of the jaws 14. Thus, each of the panels 24 is compressed against a support 26 when the locking pliers 12 are closed on the support 26. The support 26 may be a ceiling joist in a building, a piece of sheet metal and any other type of support 26 on which a pipe is suspended. The pipe may be a plumbing pipe or any other pipe that must be installed in accordance with the requirements of the International Building Code.

Each of the panels 24 has a pair of apertures 28 extending therethrough. The pair of panels 24 includes a first panel 30 and a second panel 32. Moreover, each of the apertures 28 in the first panel 30 is aligned with a respective one of the apertures 28 in the second panel 32 when the locking pliers 12 are closed. In this way the apertures 28 on each of the first panel 30 and the second panel 32 facilitate holes to be drilled through the support 26 at a precise location. The holes are drilled through the support 26 to facilitate a pipe hanger to be coupled to the support 26 in accordance with the International Building Code.

Each of the panels 24 has a first surface 34, a second surface 36 and a peripheral edge 38 extending therebetween. The first surface 34 of each of the panels 24 is coupled to the interior surface 20 of the respective jaw 14 and the peripheral edge 38 of each of the panels 24 has a front side 40 that is spaced from the respective jaw 14. The apertures 28 on each of the panels 24 extend through the first surface 34 and the second surface 36 of a respective one of the panels 24. The apertures 28 on each of the panels 24 are spaced apart from each other and the apertures 28 on each of the panels 24 are distributed along the front side 40 of the respective panel. The apertures 28 in each of the panels 24 may be spaced from the front side 40 of the respective panel a distance of approximately ¼ inch. Additionally, each of the apertures 28 in each of the panels 24 may have a diameter ranging between approximately 5/16 inch and ⅜ inch. Finally, each of the apertures 28 may be spaced approximately 9/16 inch from a respective one of a first lateral side and a second lateral side of the respective panel.

In use, the locking pliers 12 are clamped onto the support 26 at a predetermined location for drilling holes in the support 26. Each of the panels 24 is compressed onto the support 26 when the locking pliers 12 are closed. Holes are drilled, with a drill or the like, through each of the apertures 28 in the panels 24 thereby facilitating the holes to be precisely located in the support 26. In this way a pipe hanger can be installed on the support 26 in accordance with International Building Code.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hole drilling jig assembly being configured to be clamped on a support thereby facilitating a pair of holes to be drilled at precise locations in the support, said assembly comprising:
a pair of locking pliers, said locking pliers having a pair of jaws and an adjustment screw;
an eyebolt being coupled to said adjustment screw wherein said eyebolt is configured to be coupled to a pulling line for pulling on said locking pliers; and
a pair of panels, each of said panels being coupled to a respective one of said jaws wherein each of said panels is configured to be compressed against a support when said locking pliers are closed, each of said panels having a pair of apertures extending therethrough wherein said apertures are configured to facilitate holes to be drilled through the support at a precise location.

2. The assembly according to claim 1, wherein each of said jaws has an interior surface, said interior surface of each of said jaws facing each other.

3. The assembly according to claim 2, wherein each of said panels has a first surface, a second surface and a peripheral edge extending therebetween, said first surface of each of said panels being coupled to said interior surface of said respective jaw, said peripheral edge of each of said panels having a front side being spaced from said respective jaw.

4. The assembly according to claim 3, wherein said apertures on each of said panels extends through said first surface and said second surface of a respective one of said panels, said apertures on each of said panels being spaced apart from each other, said apertures on each of said panels being distributed along said front side of said respective panel.

5. The assembly according to claim 1, wherein said pair of panels includes a first panel and a second panel, each said apertures on said first panel being aligned with a respective one of said apertures on said second panel when said locking pliers are closed.

6. A hole drilling jig assembly being configured to be clamped on a support thereby facilitating a pair of holes to be drilled at precise locations in the support, said assembly comprising:
a pair of locking pliers, said locking pliers having a pair of jaws and an adjustment screw, said adjustment screw having a distal end with respect to said locking pliers, each of said jaws having an interior surface, said interior surface of each of said jaws facing each other;
an eyebolt being coupled to said distal end of said adjustment screw wherein said eyebolt is configured to be coupled to a pulling line for pulling on said locking pliers; and
a pair of panels, each of said panels being coupled to a respective one of said jaws wherein each of said panels is configured to be compressed against a support when said locking pliers are closed, each of said panels having a pair of apertures extending therethrough, said pair of panels including a first panel and a second panel, each of said apertures on said first panel being aligned with a respective one of said apertures on said second panel when said locking pliers are closed wherein said apertures on each of said first panel and said second panel are configured to facilitate holes to be drilled through the support at a precise location, each of said panels having a first surface, a second surface and a peripheral edge extending therebetween, said first surface of each of said panels being coupled to said interior surface of said respective jaw, said peripheral edge of each of said panels having a front side being spaced from said respective jaw, said apertures on each of said panels extending through said first surface and said second surface of a respective one of said panels, said apertures on each of said panels being spaced apart from each other, said apertures on each of said panels being distributed along said front side of said respective panel.
